(19) United States
(12) Patent Application Publication
(10) Pub. No.: US 2001/0017643 A1
(43) Pub. Date: Aug. 30, 2001

(54) Ink jet recording material for non-aqueous ink

(75) Inventors: Tetsuya Uto, Tokyo (JP); Takao Senga, Tokyo (JP); Kunio Kasamatsu, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: MITSUBISHI PAPER MILLS LIMITED, Tokyo (JP)

(21) Appl. No.: 09/771,975

(22) Filed: Jan. 30, 2001

(30) Foreign Application Priority Data
Jan. 31, 2000 (JP) 2000-22084
Mar. 3, 2000 (JP) 2000-58740
Mar. 16, 2000 (JP) 2000-74387
Mar. 16, 2000 (JP) 2000-74388

(51) Int. Cl. B41J 3/407

(52) U.S. Cl. 347/106

(57) ABSTRACT

An ink jet recording material for non-aqueous ink, which comprises an ink-absorbing layer containing at least a pigment on a support, the ink-absorbing layer being coated or impregnated with a polymer soluble or swellable in a petroleum system high boiling point solvent, wherein at least 30 wt % of the pigment is calcium carbonate.

The present invention relates to an ink jet recording material for non-aqueous ink, which is used for a printer or plotter employing an ink jet recording system using a non-aqueous ink. Particularly, the present invention relates to an ink jet recording material for non-aqueous ink, which is excellent in ink-absorbing property and fixing property of a non-aqueous ink containing a petroleum system high boiling point solvent.

Heretofore, an aqueous ink having a coloring agent such as a dye or a pigment dispersed or dissolved in water or a mixture of water and a hydrophilic solvent, has been often used for ink jet recording.

However, the ink jet recording system using an aqueous ink provides various problems caused when a printed part of a recording material is elongated by absorbing a solvent in the ink. The elongation of the recording material is caused by breaking hydrogen bonds between fibers maintaining a mechanical strength of a support with a solvent, particularly water, in an aqueous ink, thereby causing such undesirable phenomena as providing a bad influence on conveyance of the recording material within a printer, degrading an accuracy of a relative position between the recording material and a printer head, degrading a dimension accuracy of a printed image or producing an uneven image.

In order to solve these problems, JP-A-57-10660, JP-A-57-10661, JP-A-5-202324 and JP-A-5-331397 propose to use an ink having a coloring agent dissolved or dispersed in a non-aqueous solvent such as an isoparaffinic hydrocarbon. According to these inventions, it is possible to carry out ink jet recording without causing an elongation of a recording material at a high dimension accuracy and without producing an uneven image. Also, by employing properties of a low viscosity and a low surface tension which are characteristics of a non-aqueous solvent, it is possible to raise a driving frequency of a printer head, thereby enabling a high speed ink jet recording, as compared with an ink jet recording employing an aqueous ink.

As a recording material used for ink jet recording employing a non-aqueous ink, JP-A-64-24785 discloses a recording material comprising an oil-absorptive inorganic pigment, an organic pigment and an aqueous adhesive, and JP-A-1-255580 discloses a recording material comprising silica and an adhesive. These recording materials were a mat coat type recording material providing a recorded surface having a mat surface appearance.

On the other hand, in accordance with recent progress of an ink jet printer, it has been possible to obtain a highly precise image comparable to a silver salt photograph. In proportion to this progress, there has been demanded an ink jet recording material having a satisfactory feeling, i.e. a glossy surface, similar to a silver salt photograph print. As a matter of fact, such a recording material is required not only to provide a satisfactory gloss but also to provide a high recording image density and a high recording image precision which makes a smooth surrounding of each dot and a clear outline without causing bleeding of an ink, and is further required to be excellent in preservability of an image, i.e. fixing property of a coloring agent.

In order to satisfy these requirements, JP-A-63-265680 and JP-A-5-59694 propose an ink jet recording material having a coating layer provided by cast coating method for ink jet recording system employing an aqueous ink. Also, JP-A-6-155892 discloses a recording material having a film of a water-soluble polymer such of polyvinyl alcohol formed on a similar recording material. Further, JP-A-6-199035 discloses a recording material having an ink-absorbing layer comprising pseudoboehmite provided on a support. According to these inventions, ink jet recording materials having a high glossiness and a high aqueous ink-absorbing property can be provided. However, these recording materials are not applicable to recording system employing a non-aqueous ink since there is no affinity between a material of the recording materials and a solvent contained in the ink or a coloring agent, and therefore there are provided various defects of making distribution of a coloring agent in the recording materials so ununiform as to produce only a low image density, repelling an ink on the surface of the recording materials to cause uneven images and making a coloring agent easily separatable by slight attrition. Thus, even if these recording materials are recorded with a non-aqueous ink, it has been quite impossible to obtain a recorded image satisfactory in density, precision and preservability.

In order to solve these problems, JP-A-10-250218 proposes to produce a recording material providing a highly precise recorded image and a satisfactory fixing property of a coloring agent by incorporating a polymer soluble in an isoparaffinic hydrocarbon into a coating layer as a recording material for ink jet recording using a non-aqueous ink. The polymer soluble in an isoparaffinic hydrocarbon incorporated in a coating layer traps a coloring agent in its inside, which is dissolved in the solvent of the ink after printing. Thereafter, the solvent is dried and the ink loses its fluidity, thereby fixing the coloring agent in its inside and having the coloring agent uniformly dispersed in the inside of the recording material, and consequently a density and a precision are improved and also a fixing property of the coloring agent into the recording material is improved. However, when using a low density ink such as light cyan, light magenta or the like as a kind of an ink to be used for recording, a large amount of an ink must be charged, and consequently an ink solvent is not sufficiently absorbed and the ink is bleeded on the surface of a recording material, thereby producing uneven images and causing printing defects such as a strike through that an ink penetrates into the backside of a printing paper.

An object of the present invention is to provide an ink jet recording material for non-aqueous ink usable for a printer or a plotter employing an ink jet recording system using a non-aqueous ink, which is excellent in an ink-absorbing property and a fixing property of a non-aqueous ink and prevents a strike through of an ink and inhibits bleeding of an ink solvent from the surrounding of a printed part as a lapse of time.

The above object of the present invention can be achieved by providing the following means.

That is, the present invention provides an ink jet recording material for non-aqueous ink, excellent in a fixing property and an absorptivity of an ink solvent of a non-aqueous ink, which comprises an ink-absorbing layer containing at least a pigment on a support, the ink-absorbing layer being coated or impregnated with a polymer soluble or swellable in a petroleum system high boiling point solvent, wherein at least 30 wt % of the pigment is calcium carbonate.

Further, the present invention provides an ink jet recording material for non-aqueous ink, excellent in a fixing property and an absorptivity of an ink solvent of a non-aqueous ink, which comprises an ink-absorbing layer containing at least a pigment on a support, the ink-absorbing layer being coated or impregnated with a polymer soluble or swellable in a petroleum system high boiling point solvent, wherein at least 30 wt % of the pigment is kaolin.

Still further, the present invention provides an ink jet recording material for non-aqueous ink, excellent in an absorptivity of an ink solvent of a non-aqueous ink and a fixing property, which comprises an ink-absorbing layer containing at least a pigment on a support, the ink-absorbing layer being coated or impregnated with a polymer soluble or swellable in a petroleum system high boiling point solvent, wherein the pigment is barium sulfate.

Also, the present invention provides an ink jet recording material for non-aqueous ink, wherein an ink-absorbing layer is surface-smoothed by calendering treatment and consequently has a glossy surface.

The present invention further provides an ink jet recording material for non-aqueous ink, wherein an ink-absorbing layer is surface-smoothed by calendering treatment and consequently has a glossy surface, at least 20% of which has a 75° specular gloss.

The present invention still further provides an ink jet recording material for non-aqueous ink, wherein an ink-absorbing layer is surface-smoothed by cast treatment and consequently has a highly glossy surface.

Also, the present invention provides an ink jet recording material for non-aqueous ink, having a glossy surface, wherein a gas-permeable support such as a plain paper, a coated paper, a non-woven cloth or a fabric is used when an ink-absorbing layer is surface-smoothed by cast treatment.

Further, the present invention provides an ink jet recording material for non-aqueous ink excellent in a fixing property and an absorptivity of an ink solvent of a non-aqueous ink and inhibiting a strike through of an ink and also preventing bleeding of an ink solvent from the surrounding of a printed part as a lapse of time, which comprises an ink-absorbing layer of at least one layer on a support, the ink-absorbing layer being coated or impregnated with a polymer soluble or swellable in a petroleum system high boiling point solvent, wherein an undercoat layer containing at least one kind of a pigment selected from the group consisting of barium sulfate, calcium carbonate, titanium oxide and kaolin is provided between the support and the ink-absorbing layer.

Also, the present invention provides an ink jet recording material for non-aqueous ink, excellent in an ink-absorbing property and a fixing property of a non-aqueous ink and having a glossy surface, wherein the outermost layer of an ink-absorbing layer is a gloss-developing layer.

Further, the present invention provides an ink jet recording material for non-aqueous ink, having a glossy surface provided by cast method, in which a wet gloss-developing layer is pressed to a heated mirror-finished roll for drying to provide a gloss.

Hereinafter, the present invention is further explained in more details with reference to preferable embodiments.

An ink jet recording material for non-aqueous ink of the first invention is obtained by providing an ink-absorbing layer containing at least a pigment on a support and coating or impregnating a polymer (hereinafter referred to as a “solvent-soluble polymer”) soluble or swellable in a petroleum system high boiling point solvent on the ink-absorbing layer, and is characterized in that at least 30% of the pigment is calcium carbonate.

By using calcium carbonate in an amount of at least 30 wt % as a pigment, an ink-absorbing property becomes excellent and bleeding of an ink solvent from the surrounding of a printed part as a lapse of time can be prevented.

It is not clear why calcium carbonate prevents an ink solvent of a non-aqueous ink from bleeding, but calcium carbonate has a high affinity with a solvent of a non-aqueous ink and it is considered that calcium carbonate has a higher ability of adsorbing and holding a bleeded solvent on the surface of a pigment, as compared with silica or the like which is a pigment usually used in an aqueous ink jet recording material.

Calcium carbonate used in the first invention is classified into two kinds, one of which is a naturally occurring material (heavy calcium carbonate) obtained by physically pulverizing limestone as it is and the other of which is a precipitated calcium carbonate (light calcium carbonate, ultrafine calcium carbonate or the like) obtained by chemically reacting various starting materials, and any of the two kinds of calcium carbonate can be used in the present invention.

Also, calcium carbonate has an average particle size in a range of from 0.04 to 8 μm, preferably from 0.4 to 1.5 μm. By using calcium carbonate having a particle size in such a range, an absorbing property of an ink solvent can be satisfied. If the average particle size is smaller than 0.04 μm a viscosity of a coating solution is unpreferably raised and an adhesiveness to a substrate becomes poor. On the other hand, if the average particle size is larger than 8 μm, smoothness of a surface becomes poor, and an ink-absorbing property becomes uneven and a gloss is lowered.

An ink jet recording material for non-aqueous ink of the second invention is obtained by providing an ink-absorbing layer containing at least a pigment on a support and coating or impregnating a polymer (hereinafter referred to as a “solvent-soluble polymer”) soluble or swellable in a petroleum system high boiling point solvent on the ink-absorbing layer, and is characterized in that at least 30% of the pigment is kaolin.

By using kaolin in an amount of at least 30 wt % as a pigment, an ink-absorbing property becomes excellent and bleeding of an ink solvent out of the surrounding of a printed part as a lapse of time can be prevented.

It is not clear why kaolin prevents an ink solvent of a non-aqueous ink from bleeding, but kaolin has a very strong affinity with a solvent of a non-aqueous ink, and it is considered that it has a higher ability of adsorbing and holding a solvent percolated on the surface of a pigment, as compared with silica or the like which is usually used as a pigment for an aqueous ink jet recording material.

Kaolin used in the second invention is kaolin mineral in clay mineral, and is purified to improve purity and whiteness like kaolin which is now commercially available. Purification treatment can be carried out by a well known method, and can be carried out by any of dry method and wet method, but a product obtained by wet method is more preferable since the product becomes homogeneous and does not contain contaminants.

Also, kaolin has an average particle size in a range of from 0.4 to 8 μm, preferably from 0.5 to 3.5 μm. By using kaolin having an average particle size in such a range, an absorbing property of an ink solvent can be satisfactory. If the average particle size is smaller than 0.4 μum, a viscosity of a coating solution is unpreferably raised and an adhesiveness to a substrate becomes poor. On the other hand, if the average particle size is larger than 8 μm, smoothness of a surface becomes poor, and an ink-absorbing property becomes uneven and a gloss is unpreferably lowered.

As a pigment used in an ink-absorbing layer, if calcium carbonate is used in the first invention and kaolin is used in the second invention respectively in a amount of at least 30 wt %, other well known pigments may be used in combination with one or more kinds. Examples of other pigments usable in combination therewith include inorganic pigments such as talc, calcium sulfate, barium sulfate, titanium dioxide, zinc oxide, zinc carbonate, satin white, aluminum silicate, diatomaceous earth, calcium silicate, magnesium silicate, synthetic amorphous silica, colloidal silica, colloidal alumina, pseudoboehmite, aluminum hydroxide, alumina, zeolite, magnesium carbonate, magnesium hydroxide or the like, and organic pigments such as styrene type plastic pigment, acryl type plastic pigment, polystyrene, micro-capsule, urea resin, melamine resin or the like, but are not limited thereto. If calcium carbonate or kaolin is not contained in an amount of at least 30 wt % as a pigment for an ink-absorbing layer, an ink-absorbing property becomes poor and an ink solvent is unpreferably bleeded out of the surrounding of a printed part as a lapse of time.

Also, an ink jet recording material for non-aqueous ink of the third invention is obtained by providing an ink-absorbing layer containing at least a pigment on a support and coating or impregnating a polymer (hereinafter referred to as a “solvent-soluble polymer”) soluble or swellable in a petroleum system high boiling point solvent on the ink-absorbing layer, and is characterized in that the pigment is barium sulfate.

By using barium sulfate as a pigment, an ink-absorbing property becomes excellent and bleeding of an ink solvent out of the surrounding of a printed part as a lapse of time can be prevented.

It is not clear why barium sulfate can prevent an ink solvent of a non-aqueous ink from bleeding, but barium sulfate has a very strong affinity with a solvent of a non-aqueous ink, and it is considered that it has a higher ability of adsorbing and maintaining a solvent percolated on the surface of a pigment, as compared with silica or the like which is usually used as a pigment for an aqueous ink jet recording material.

Barium sulfate can be obtained by various preparation methods, one of which comprises adding a 5 to 20% aqueous solution of neutral crystalline sodium sulfate to a 5 to 20% aqueous solution of neutral crystalline barium chloride or adding a 5 to 20% aqueous solution of neutral crystalline barium chloride to a 5 to 20% aqueous solution of neutral crystalline sodium sulfate with stirring and then reacting the resultant mixture to produce barium sulfate. Barium sulfate obtained by this method has a sulfide content of only at most 0.01 ppm. Since the sulfide content as an impurity in this barium sulfate is small, this barium sulfate does not cause coloration and has an excellent weather resistance.

Barium sulfate has an average particle size in a range of from 0.3 to 3 μm, preferably from 0.4 to 1.5 μm.

By using barium sulfate having a particle size in such a range, an absorbing property of an ink solvent can be 25 satisfactory. If the average particle size is smaller than 0.3 μm, a viscosity of a coating solution is unpreferably raised and an adhesiveness to a substrate becomes poor. On the other hand, if the average particle size is larger than 3 μm, smoothness of a surface becomes poor, and an ink-absorbing property becomes uneven and a gloss is unpreferably lowered.

Examples of a binder used to bind pigments in an ink-absorbing layer include natural high molecular resins or their derivatives such as starch and its modified products, gelatin and its modified products, casein, pullulan, gum Arabic, karaya gum, albumin or the like, polyvinyl alcohol or its cation-modified product or silanol-modified product, latexes such as SBR latex, NBR latex, methyl methacrylate-butadien copolymer, ethylene-vinyl acetate copolymer or the like, vinyl polymers such as polyacrylamide, polyvinyl pyrrolidone or the like, polyethylene imine, polypropylene glycol, polyethylene glycol, maleic anhydride polymer or its copolymer, and the like. They may be used respectively alone or in a mixture of two or more.

In addition to these pigments and binders, a coating solution for forming an ink-absorbing layer may further contain various known additives such as a surfactant, a coloring dye, a coloring pigment, a cationic ink dye-fixing agent, a UV-ray absorber, an antioxidant, a dispersant for pigments, a defoaming agent, a leveling agent, an antiseptic agent, a fluorescent whitening agent, a viscosity stabilizer, a pH regulator and the like.

A coating amount of an ink-absorbing layer on a support is preferably in a range of from 5 to 50 g/m², more preferably from 10 to 30 g/m², in order to provide a satisfactory absorbing property of a solvent in an ink and a satisfactory smoothness of a surface.

An ink-absorbing layer is coated and dried by using a coating apparatus. Examples of a coating method of a coating solution include slide hopper system, curtain system, extrusion system, air knife system, roll coating system, rod bar coating system and the like, which are generally used.

Further, an ink jet recording material for non-aqueous ink of the fourth invention is an ink jet recording material for non-aqueous ink obtained by providing an ink-absorbing layer of at least one layer on a support, the ink-absorbing layer containing a polymer (hereinafter referred to as a “solvent-soluble polymer”) soluble or swellable in a petroleum system high boiling point solvent, characterized in that an undercoat layer containing at least one kind of pigment selected from the group consisting of barium sulfate, calcium carbonate, titanium oxide and kaolin is provided between the support and the ink-absorbing layer.

The undercoat layer in the fourth invention has a function of absorbing and holding an ink solvent of non-aqueous ink by such a pigment as illustrated below, thereby preventing a “strike through” of an ink through a paper to be printed and also preventing the ink solvent from bleeding out of the surrounding of a printed part as a lapse of time.

Examples of a pigment to be used in the undercoat layer include inorganic pigments such as barium sulfate, calcium carbonate, titanium oxide, kaolin and the like.

It is not clear why these pigments prevent an ink solvent of a non-aqueous ink from penetrating through a paper to be printed, but it is considered that these pigments have a very high affinity to a solvent of non-aqueous ink, and it is considered that they are excellent in absorbing and holding these penetrated solvents on the surface of the pigments. Among these pigments, barium sulfate is particularly preferable as used in the above mentioned third invention.

Also, a pigment to be used in the undercoat layer has an average particle size in a range of from 0.02 to 3 μm, preferably from 0.1 to 2.0 μm. By using a pigment having a particle size in such a range, a property of absorbing an ink solvent is satisfied. If the average particle size is smaller than 0.02 μm, a viscosity of a coating solution is raised and an adhesiveness to a support is unpreferably poor. On the other hand, if the average particle size is larger than 3 μm, smoothness of a surface becomes poor, and an ink-absorbing property becomes unpreferably uneven.

Examples of a binder to bind pigments in an undercoat layer include natural high molecular resins or their derivatives such as starch and its modified product, gelatin and its modified product, casein, pullulan, gum Arabic, karaya gum, albumin or the like, polyvinyl alcohol or its cation-modified product or silanol-modified product, latexes such as SBR latex, NBR latex, methyl methacrylate-butadiene copolymer, ethylene-vinyl acetate copolymer or the like, vinyl polymers such as polyacrylamide, polyvinyl pyrrolidone or the like, polyethylene imine, polypropylene glycol, polyethylene glycol, maleic anhydride polymer or its copolymer, and the like, and they may be used alone or in a mixture of two or more.

A coating amount of an undercoat layer on a support is preferably in a range of from 1 to 40 g/m², more preferably from 5 to 20 g/m², in order to provide a satisfactory property of absorbing a solvent of an ink and a satisfactory smoothness of a surface.

The undercoat layer is formed by coating and drying by using a coating apparatus. A coating solution is coated by a coating method employing slide hopper system, curtain system, extrusion system, air knife system, roll coating system, rod bar coating system or the like, which is generally used.

The outermost layer of the ink-absorbing layer in the fourth invention is provided with a gloss-developing layer comprising colloid particles to raise a glossiness of the ink-absorbing layer. The gloss-developing layer provides also a solvent-absorbing property by a vacant space present between colloid particles.

Various materials can be used as colloid particles for forming a gloss-developing layer, examples of which include inorganic colloid particles such as alumina (hydrate) including pseudoboehmite, boehmite or the like, silica, titania, and the like. Among them, colloid particles comprising alumina and silica are particularly preferable since they provide a strong bonding force between colloid particles and form a gloss-developing layer having a high mechanical strength.

Various methods can be used as a method for forming a gloss-developing layer from such colloid particles, examples of which include a method for coating a colloid particle dispersion comprising alumina sol, silica sol or the like, or a coating solution of these colloid particles or a mixture of colloid particles and an appropriate binder, on a support and then simply drying. Also, in addition to this method, it is possible to form a gloss-developing layer by a cast method which comprises coating a coating solution of a gloss-developing layer and then pressing the gloss-developing layer in wet state to a mirror-finished roll or pressing a gloss-developing layer after drying and wetting again to mirror-finished roll, thereby transferring the shape of the mirror-finished roll surface to the gloss-developing layer. This method is more preferable than the method comprising simply coating and drying since a higher gloss can be obtained.

A solvent-soluble polymer in the present invention has an effect of improving a fixing property of a coloring agent to a recording medium by being dissolved in a solvent of an ink after printing, trapping a coloring agent in its inside, and then fixing the coloring agent in the inside by evaporating the solvent and reducing fluidity.

Such a solvent-soluble polymer is dissolved or swelled in a petroleum type high boiling point solvent in an optional ratio at room temperature, and various polymers satisfying this condition can be used. Examples of the solvent-soluble polymer include poly(1,3-diene) such as polybutadiene, polyisoprene or the like, polyalkyl (at least C4) vinyl ether, polyvinyl alkyl(at least C4) carboxylate, polyalkyl (at least C4) (meth)acrylate, polyalkyl (at least C6) (meth)acrylamide, polyoxy alkylene (at least C4), polydimethylsiloxane, petroleum resin (C5 system, C9 system), novolac resin, gudderperca polymer, and the like, and comonomers comprising monomers constituting these polymers may be used as a solvent-soluble polymer in the present invention.

These solvent-soluble polymers may be modified with various materials, provided that their solubility to a petroleum type high boiling point solvent is not lost. For example, a polymer soluble in a petroleum type high boiling point solvent used in the present invention may be modified by copolymerizing a monomer constituting the above polymers with a monomer such as lower alkylvinyl ether, vinyl lower alkylcarboxylate, lower alkyl (meth)acrylate, (meth)acrylic acid, tetrahydrofurfuryl (meth)acrylate, alkyloxyethyl (meth)acrylate, dialkylaminoethyl (meth)acrylate, lower alkyl(meth)acrylamide, (meth)acrylamide, lower(di)alkyl(meth)acrylamide, diacetone(meth)acrylamide, 2-(meth)acrylamide-2-methylpropane sulfonic acid, dialkylaminopropyl(meth)acrylamide, styrene or the like.

A method for incorporating a solvent-soluble polymer into an ink-absorbing layer can be carried out preferably by dissolving the solvent-soluble polymer in an appropriate organic solvent and coating. According to this method, it is possible to have the solvent-soluble polymer existed concentratedly on the surface part of a recording material, thereby efficiently achieving an effect of incorporating the solvent-soluble polymer.

A coating amount of a solvent-soluble polymer on an ink-absorbing layer is preferably in a range of from 0.3 to 15 g/m², more preferably from 3 to 10 g/m². If the coating amount is less than this range, it is impossible to strongly fix a coloring agent, and a property of fixing the coloring agent becomes poor. On the other hand, if the coating amount is more than this range, an ink-absorbing layer speed becomes insufficient, and an uneven image unpreferably occurs.

Examples of a method for coating this solvent-soluble polymer include a method of using a roll coater, an air knife coater, a blade coater, a rod coater, a bar coater, a gravure coater, a curtain coater or the like, which is generally used, but the present invention is not limited thereto.

An ink-absorbing layer in the first invention, the second invention or the third invention may be subjected to surface-smoothing treatment by passing through rolls under a pressure by using a processing apparatus such as a super calender. By making the surface, at least 20% of which has a 75° specular gloss, such a gloss as a photograph or art paper, coat paper or the like can be satisfactorily obtained.

The ink-absorbing layer in the first invention, the second invention or the third invention may be preferably subjected to surface-smoothing treatment by a cast method which comprises pressing a coating layer in wet state to a heated mirror-finished roll or pressing a coating layer to a heated mirror-finished roll after drying and re-wetting, and then transferring the mirror surface by drying and releasing.

A support to be used in the present invention may be any of transparent or opaque substrates. Examples of the support include a transparent film such as polyester, polysulfone, polyvinyl chloride, polycarbonate, polystyrene, polymethyl methacrylate, cellulose acetate, polyethylene, polypropylene or the like, or a film whitened by filling a white pigment or finely foaming, a synthetic paper, a plain paper, a coated paper, a baryta paper, a resin-coated paper or the like. Further, any support such as glass, an aluminum foil, a vapor-deposited paper, a vapor-deposited film, a fabric or the like, on which an ink-absorbing layer can be provided, may be used. Thus, the support is not specially limited, but a paper having a gas-permeability such as a plain paper, a coated paper, a fabric or the like is preferable. Particularly, in the embodiment of the fourth invention employing cast-finishing to provide a gloss-developing layer, it is preferable to use a support such as a gas-permeable paper.

Particularly, when subjecting to surface-smoothing treatment by a cast treatment method in the first invention, the second invention or the third invention, a coated surface in wet state is made in close contact with a cast drum to dry, and it is therefore necessary to evaporate a water content from the backside of a support. If a support not having a gas-permeability is used, it is impossible to evaporate a water content from the backside of the support, thereby producing bubbles between the coated surface and the cast drum surface, so that an uneven surface is produced without producing a mirror-finish surface. Thus, it is preferable to use a gas-permeable support.

As an index for measuring a gas-permeability of a support in the first invention, the second invention or the third invention, it is preferable to have a gas-permeability of at most 1,000 seconds, more preferably at most 500 seconds, measured in accordance with JIS P 8117 when subjected to surface-smoothing treatment by a cast treatment method. If the gas-permeability is more than 1,000 seconds, bubbles tend to occur between a coated surface and a cast drum surface.

In order to improve adhesiveness, an anchor layer may be provided on a support in the present invention. The anchor layer may comprise a hydrophilic binder such as gelatin, a solvent-soluble binder such as polyvinyl butyral, a latex, a curing agent, a pigment, a surfactant and the like in an appropriate combination.

The support of the present invention may further be provided with various back coat layers to impart an antistatic property, a sliding or conveying property, a curl-preventing property, a writability, a sizing property and the like. The back coat layers may comprise an inorganic antistatic agent, an organic antistatic agent, a hydrophilic binder, a latex, a curing agent, a pigment, a lubricant, a surfactant and the like in an appropriate combination.

As a non-aqueous ink of the present invention, an ink having a coloring agent dissolved or dispersed in a non-aqueous solvent is used.

The non-aqueous solvent is selected from various solvents so as to be compatible with performances of an ink-ejecting head of an ink jet recording apparatus or in view of safety, and a mixture of a plurality of solvents may also be used in some cases.

Typical examples of such solvents include petroleum naphtha type solvents such as Pegasol (manufactured by Mobil Petroleum Company), Shell SBR, Shellsol® (manufactured by Shell Petrochemical Company) and the like, aromatic petroleum solvents such as HISOL (manufactured by NIPPON PETROCHEMICALS CO., LTD.), and the like, aliphatic petroleum solvents such as Soltol (manufactured by Philips Petroleum Company), Exosol, ISOPAR® (manufactured by Exxon Chemical JAPAN INC.), IP solvent (manufactured by Idemitsu Petrochemical Co., Ltd.) and the like, naphthene type petroleum solvents such as Inksolvent (manufactured by Mitsubishi Oil Co., Ltd.), and the like.

Examples of a coloring agent to be used in the non-aqueous ink include dissolved or dispersed oil-soluble dyes such as a naphthol dye, an azo dye, a metal complex salt dye, an anthraquinone dye, a quinoimine dye, an indigo dye, a cyanine dye, a quinoline dye, a nitro dye, a nitroso dye, a benzoquinone dye, a carbonium dye, a naphthoquinone dye, a naphthalimide dye, a phthalocyanine dye, a pellinine dye or the like, carbon blacks such as furnaced black, lamp black, acetyrene black, channel black or the like, organic pigments such as orthonitroaniline black, or the like, toluidine red, permanent carmine FB, first yellow AAA, disazoorange PMP, lake red C, brilliant carmine 6B, phthalocyanine blue, quinacridone red, dioxane violet, Victoria pure blue, alkali blue toner, first yellow lOG, orthonitroaniline orange, toluidine red, barium red 2B, calcium red 2B, pigment scarlet 3B lake, ansocine 3B lake, rhodamine 6G lake, methyl violet lake, basic blue 5B lake, first sky blue, alkali blue R toner, Berlin blue, ultramarine blue, reflex blue 2G, brilliant green lake, phthalocyanine green G, iron oxide powder, zinc white, calcium carbonate, clay, barium sulfate, alumina white, aluminum powder, dayglow fluorescent pigment, pearl pigment, and the like, and also surface-treated pigments of the above illustrated pigments may be used, but it is not limited thereto.

Also, in order to improve preservation stability and anti-marring properties after printing, the non-aqueous ink may further contain a polar resin such as polyacrylic acid ester, linseed oil-modified alkyd resin, polystyrene, rosin type resin, terpene phenol type resin, alkylphenol-modified xylene resin or the like, a metal sealing agent, a surface tension modulator, a surfactant, a viscosity modulator, a defoaming agent, a foam-inhibiting agent, a release agent, a foaming agent, a penetrating agent, a fluorescent whitening agent, a UV-ray absorber, an anti-rotting agent, an anti-hydrating agent, a rheology modifier, an anti-oxidant, and other additives, in an appropriate combination.

### EXAMPLES

Hereinafter, the present invention is further explained with reference to Examples, but the present invention should not be limited to the Examples. In the Examples, “part” means “part by weight” unless otherwise specified.

First, a method for evaluation is explained hereinafter. Ink jet recording materials for non-aqueous ink prepared in Examples and Comparative Examples were evaluated in the following manner by printing square-shaped solid-printed patterns of mono color (each of cyan, magenta, yellow and black), two color-overlapped color (cyan+magenta, magenta+yellow and cyan+yellow) and three color-overlapped color (cyan+magenta+yellow) by means of an ink jet printer (PJ3600: manufactured by Olympus Optical Co., Ltd.)

Evaluation Method

(Glossiness)

The evaluation of “glossiness” was made by measuring a 75° specular gloss (Gs) of an unprinted part by using a glossmeter (GM-26D type, manufactured by MURAKAMI COLOR LABORATORY RESEARCH) in accordance with JIS-Z-8741.

(Fixing Property)

The evaluation of “fixing property” was made by rubbing the surface of a black ink solid-printed part with an index finger one time in one direction. By rubbing with an index finger, a sample, the solid-printed coloring agent of which was not extended to a blank paper part (unprinted part) surrounding the solid-printed part, was evaluated to have a satisfactory fixing property (expressed by the symbol “∘”), and a sample, the solid-printed coloring agent of which did not cause a substantial problem but was slightly extended to a blank paper part (unprinted part) surrounding the solid-printed part, was evaluated to have a medium fixing property (expressed by the symbol “Δ”) and a sample, the solid-printed coloring agent of which was separated from the surface of the solid-printed part, was evaluated to have a bad fixing property (expressed by the symbol “×”).

(Ink-Absorbing Property)

The evaluation of “ink-absorbing property” was made by visually observing a dry state of an ink of a solid-printed part immediately after printing each of monocolor, double color and triple color. A sample, the solid-printed ink of which was absorbed satisfactorily and printed completely without causing any overflowing, was evaluated to have a satisfactory ink-absorbing property (expressed by the symbol “∘”), and a sample, the solid-printed ink of which did not raise a practical problem but was slightly overflowed and caused uneven printing, was evaluated to have a medium ink-absorbing property (expressed by the symbol “Δ”), and a sample, the solid-printed ink of which was severely overflowed, was evaluated to have a bad ink-absorbing property (expressed by the symbol “×”).

(Strike through of Ink)

The evaluation of “strike through of ink” was made by visually observing the backside of a three color-overlapped solid-printed part to visually evaluate “strike through” of an ink to the backside of the printed paper. A sample, the strike through of ink of which was not observed at all, was evaluated to have a satisfactory performance of preventing strike through of ink (expressed by the symbol “∘”), and a sample, the strike through of ink of which was slightly observed, was evaluated to have a medium performance of preventing strike through of ink (expressed by the symbol “Δ”), and a sample, the strike through of ink of which was severely observed, was evaluated to have a poor performance of preventing strike through of ink (expressed by the symbol “×”). The evaluation of “∘” is practically satisfactory.

(Bleeding Property)

The evaluation of “bleeding property” was made by visually observing “bleeding” of an ink solvent out of the surrounding of a three color-overlapped solid-printed part after 24 hours. A sample, the bleeding of which was not observed at all, was evaluated to have a satisfactory anti-bleeding property (expressed by the symbol “∘”), and a sample, the bleeding of which did not raise a practical problem but was slightly observed, was evaluated to have a medium anti-bleeding property (expressed by the symbol “Δ”), and a sample, the bleeding of which was severely observed, was evaluated to have a poor anti-bleeding property (expressed by the symbol “×”)

(Preparation of Support A)

Support A was obtained by incorporating 5 parts of a pigment comprising light calcium carbonate/heavy calcium carbonate/talc (ratio of=30/35/35), 0.1 part of a commercially available alkyl ketene dimer, 0.03 part of a commercially available cationic polyacrylamide, 1.0 part of a commercially available cationized starch and 0.5 part of aluminum sulfate into a wood pulp comprising 100 parts of LBKP having a freeness of 450 mQCSF, and applying the resultant mixture to a Fourdrinier paper-making machine to obtain support A having a weight of 110 g/m². The support A thus obtained had a gas-permeability of 25 seconds.

### Example I-1

(Preparation of Ink-Absorbing layer A1)

100 Parts by weight of light calcium carbonate (Albagloss: particle size 0.6-0.8 μm, manufactured by Mintec Japan K.K.), 8 parts by weight of polyvinyl alcohol (PVA-117: manufactured by Kuraray Co., Ltd.) and 0.24 part of glyoxal (Glyoxal GX: 40% aqueous solution, manufactured by Nihon Gosei Kagaku K.K.) were blended to prepare a coating solution. The coating solution thus prepared was coated on the above prepared support A in an amount of 20 g/m² to prepare “ink-absorbing layer A1”.

(Preparation and Coating of Solvent-Soluble Polymer Coating Solution)

100 Parts of xylene as a solvent was charged into a four-necked flask equipped with a stirrer, and was heated to 70° C. in a water bath while passing nitrogen thereinto. Further, 5 parts of 2,2′-azobis(2-methylbutyronitrile) as a polymerization initiator was added thereto, and a mixture of 50 parts of lauryl methacrylate and 50 parts of isobornyl methacrylate was dropwise added thereto for 4 hours, and after finishing the dropwise adding, the mixture was maintained at 70° C. for further 4 hours. Thereafter, the mixture was heated to 90° C., and this temperature was maintained for 2 hours to obtain a polymer solution. The polymer solution thus obtained was spread thinly on a glass plate, and after drying at 80° C., the dry film was separated and was dissolved in a 4 times weight amount of Isopar G® while stirring. Also, this polymer solution was evaporated to dryness by a rotary evaporator, and was dissolved in Isopar G® to prepare a solvent-soluble polymer coating solution having a concentration of 20%.

The coating solution thus prepared was coated on the above “ink-absorbing layer A1” in an amount of 5 g/m² to obtain an ink jet recording material for a non-aqueous ink of Example I-1.

### Example I-2

(Preparation of Ink-Absorbing Layer B1)

The above prepared “ink-absorbing layer A1” was subjected to super-calendering treatment under a linear pressure of 1862 N/cm to obtain “ink-absorbing layer B1”, and a solvent-soluble polymer coating solution was coated on the ink-absorbing layer B1 in the same manner as in Example I-1 to obtain an ink jet recording material for non-aqueous ink of Example I-2.

### Example I-3

(Preparation of Ink-Absorbing Layer C1)

100 Parts by weight of light calcium carbonate (Albagloss: particle size 0.6 to 0.8 μm, manufactured by Mintec Japan K.K.), 8 parts by weight of polyvinyl alcohol (PVA-117: manufactured by Kuraray Co., Ltd.) and 0.24 part of glyoxal (Glyoxal GX: 40% aqueous solution, manufactured by Nihon Gosei Kagaku K.K.) were blended to prepare a coating solution. The coating solution thus prepared was coated on the above prepared support A in an amount of 20 g/m² by an air knife coater, and was dried by pressing the coated surface to a mirror-finished roll having a surface temperature of 90° C. to prepare “ink-absorbing layer C1”, and a solvent-soluble polymer coating solution was coated on the ink-absorbing layer C1 in the same manner as in Example I-1 to obtain an ink jet recording material for non-aqueous ink of Example I-3.

### Example I-4

(Preparation of Ink-Absorbing Layer D1)

“Ink-absorbing layer D1” was prepared in the same manner as in Example I-1, except that 50 parts by weight of light calcium carbonate (Albagloss: particle size 0.6 to 0.8 μm, manufactured by Mintec Japan K.K.) and 50 parts by weight of synthetic amorphous silica (Mizukasil P78A®: average particle size 3.3 μm, manufactured by Mizusawa Industrial Chemicals Ltd.) were used in place of 100 parts by weight of light calcium carbonate, and a solvent-soluble polymer coating solution was coated on the above prepared ink-absorbing layer D1 in the same manner as in Example I-1 to obtain an ink jet recording material for non-aqueous ink of Example I-4.

### Example I-5

(Preparation of Ink-Absorbing Layer E1)

The above prepared “ink-absorbing layer D1” was subjected to super-calendering treatment under a linear pressure of 1862 N/cm to prepare “ink-absorbing layer E1”, and a solvent-soluble polymer coating solution was coated on the ink-absorbing layer E1 in the same manner as in Example I-1 to obtain an ink jet recording material for non-aqueous ink of Example I-5.

### Example I-6

(Preparation of Ink-Absorbing Layer F1)

50 Parts by weight of light calcium carbonate (Albagloss: particle size 0.6 to 0.8 μm, manufactured by Mintec Japan K.K.) and 50 parts by weight of synthetic amorphous silica (Mizukasil P78A®: average particle size 3.3 μm, manufactured by Mizusawa Industrial Chemicals Ltd.), 8 parts by weight of polyvinyl alcohol (PVA-117: manufactured by Kuraray Co., Ltd.) and 0.24 part of glyoxal (Glyoxal GX: 40% aqueous solution, manufactured by Nihon Gosei Kagaku K.K.) to prepare a coating solution. The coating solution thus prepared was coated on the above prepared support A in an amount of 20 g/m² by an air knife coater, and was dried by pressing the coated surface to a mirror-finished roll having a surface temperature of 90° C. to prepare “ink-absorbing layer F1”, and a solvent-soluble polymer coating solution was coated on the ink-absorbing layer F1 in the same manner as in Example I-1 to obtain an ink jet recording material for non-aqueous ink of Example I-6.

### Example I-7

(Preparation of Ink-Absorbing Layer G1)

“Ink-absorbing layer G1” was prepared in the same manner as in Example I-1, except that 35 parts by weight of light calcium carbonate (Albagloss: particle size 0.6 to 0.8 μm, manufactured by Mintec Japan K.K.) and 65 parts by weight of synthetic amorphous silica (Mizukasil P78A®: average particle size 3.3 pm, manufactured by Mizusawa Industrial Chemicals Ltd.) were used in place of 100 parts by weight of light calcium carbonate, and a solvent-soluble polymer coating solution was coated on the ink-absorbing layer G1 in the same manner as in Example I-1 to obtain an ink jet recording material for non-aqueous ink of Example I-7.

### Example I-8

(Preparation of Ink-Absorbing Layer H1)

The above prepared “ink-absorbing layer G1” was subjected to super-calendering treatment under a linear pressure of 1862 N/cm to prepare “ink-absorbing layer H1”, and a solvent-soluble polymer coating solution was coated on the ink-absorbing layer H1 in the same manner as in Example I-1 to obtain an ink jet recording material for non-aqueous ink of Example I-8.

### Example I-9

(Preparation of Ink-Absorbing Layer I1)

35 Parts by weight of light calcium carbonate (Albagloss: particle size 0.6 to 0.8 μm, manufactured by Mintec Japan K.K.), 65 parts by weight of synthetic amorphous silica (Mizukasil P78A@: average particle size 3.3 μm, manufactured by Mizusawa Industrial Chemicals Ltd.), 8 parts by weight of polyvinyl alcohol (PVA-117: manufactured by Kuraray Co., Ltd.) and 0.24 part of glyoxal (Glyoxal GX: 40% aqueous solution, manufactured by Nihon Gosei Kagaku K.K.) were blended to prepare a coating solution. The coating solution thus prepared was coated on the above prepared support A in an amount of 20 g/m² by an air knife coater, and was dried by pressing the coated surface to a mirror-finished roll having a surface temperature of 90° C. to prepare “ink-absorbing layer II”, and a solvent-soluble polymer coating solution was coated on the ink-absorbing layer I1 in the same manner as in Example I-1 to obtain an ink jet recording material for non-aqueous ink of Example I-9.

### Comparative Example I-1

(Preparation of Ink-Absorbing Layer J1)

“Ink-absorbing layer J1” was prepared in the same manner as in Example I-1, except that 100 parts by weight of synthetic amorphous silica (Mizukasil P78A®: average particle size 3.3 μm, manufactured by Mizusawa Industrial Chemicals Ltd.) was used in place of 100 parts by weight of light calcium carbonate, and a solvent-soluble polymer coating solution was coated on the ink-absorbing layer J1 in the same manner as in Example I-1 to obtain an ink jet recording material for non-aqueous ink of Comparative Example I-1.

### Comparative Example I-2

(Preparation of Ink-Absorbing Layer K1)

“Ink-receiving layer K1” was prepared in the same manner as in Example I-1, except that 20 parts by weight of light calcium carbonate (Albagloss: particle size 0.6 to 0.8 μm, manufactured by Mintec Japan K.K.) and 80 parts by weight of synthetic amorphous silica (Mizukasil P78A®: average particle size 3.3 μm, manufactured by Mizusawa Industrial Chemicals Ltd.) were used in place of 100 parts by weight of light calcium carbonate, and a solvent-soluble polymer coating solution was coated on the ink-absorbing layer K1 in the same manner as in Example I-1 to obtain an ink jet recording material for non-aqueous ink of Comparative Example I-2.

### Comparative Example I-3

(Preparation of Ink-Absorbing Layer L1)

The above prepared “ink-absorbing layer K1” was subjected to super-calendering treatment under a linear pressure of 1862 N/cm to prepare “ink-absorbing layer L1”, and a solvent-soluble polymer coating solution was coated on the ink-absorbing layer L1 in the same manner as in Example I-1 to obtain an ink jet recording material for non-aqueous ink of Comparative Example I-3.

### Comparative Example I-4

(Preparation of Ink-Absorbing Layer M1)

20 Parts by weight of light calcium carbonate (Albagloss: particle size 0.6 to 0.8 μm, manufactured by Mintec Japan K.K.), 80 parts by weight of synthetic amorphous silica (Mizukasil P78A®: average particle size 3.3 μm, manufactured by Mizusawa Industrial Chemicals Ltd.), 8 parts by weight of polyvinyl alcohol (PVA-117: manufactured by Kuraray Co., Ltd.) and 0.24 part by weight of glyoxal (Glyoxal GX: 40% aqueous solution, manufactured by Nihon Gosei Kagaku K.K.) were blended to prepare a coating solution. The coating solution thus prepared was coated on the above prepared support A in an amount of 20 g/m² by an air knife coater, and was dried by pressing the coated surface to a mirror-finished roll having a surface temperature of 90° C. to prepare “ink-absorbing layer M1”, and a solvent-soluble polymer coating solution was coated on the ink-absorbing layer M1 in the same manner as in Example I-1 to obtain an ink jet recording material for non-aqueous ink of Comparative Example I-4.

### Comparative Example I-5

An ink jet recording material for non-aqueous ink of Comparative Example I-5 was obtained in the same manner as in Example I-1, except that a solvent-soluble polymer coating solution was not coated.

### Comparative Example I-6

An ink jet recording material for non-aqueous ink of Comparative Example I-6 was obtained in the same manner as in Example I-2, except that a solvent-soluble polymer coating solution was not coated.

### Comparative Example I-7

An ink jet recording material for non-aqueous ink of Comparative Example I-7 was obtained in the same manner as in Example I-3, except that a solvent-soluble polymer coating solution was not coated.

### Comparative Example I-8

An ink jet recording material for non-aqueous ink of Comparative Example I-8 was obtained in the same manner as in Example I-4, except that a solvent-soluble polymer coating solution was not coated.

### Comparative Example I-9

An ink jet recording material for non-aqueous ink of Comparative Example I-9 was obtained in the same manner as in Example I-5, except that a solvent-soluble polymer coating solution was not coated.

### Comparative Example I-10

An ink jet recording material for non-aqueous ink of Comparative Example I-10 was obtained in the same manner as in Example I-6, except that a solvent-soluble polymer coating solution was not coated.

### Comparative Example I-11

An ink jet recording material for non-aqueous ink of Comparative Example I-11 was obtained in the same manner as in Example I-7, except that a solvent-soluble polymer coating solution was not coated.

### Comparative Example I-12

An ink jet recording material for non-aqueous ink of Comparative Example I-12 was obtained in the same manner as in Example I-8, except that a solvent-soluble polymer coating solution was not coated.

### Comparative Example I-13

An ink jet recording material for non-aqueous ink of Comparative Example I-13 was obtained in the same manner as in Example I-9, except that a solvent-soluble polymer coating solution was not coated.

The ink jet recording materials for non-aqueous ink obtained in Examples I-1 to I-9 and Comparative Examples I-1 to I-13 were evaluated as mentioned above, and the evaluation results are shown in the following Table 1.

TABLE 1

| | Ink- | Solvent- | | | Ink-absorbing property | | | Ink | |
|---|---|---|---|---|---|---|---|---|---|
| | absorbing | soluble | | Fixing | Mono | Double | Triple | strike | Bleeding |
| | layer | polymer | Glossiness | property | color | color | color | through | property |
| Ex. I-1 | A1 | Presence | 23.5 | ◯ | ◯ | ◯ | Δ | ◯ | ◯ |
| Ex. I-2 | B1 | Presence | 49.5 | ◯ | ◯ | ◯ | Δ | ◯ | ◯ |
| Ex. I-3 | C1 | Presence | 71.9 | ◯ | ◯ | ◯ | Δ | ◯ | ◯ |
| Ex. I-4 | D1 | Presence | 19.8 | ◯ | ◯ | ◯ | Δ | ◯ | ◯ |
| Ex. I-5 | E1 | Presence | 37.4 | ◯ | ◯ | ◯ | Δ | ◯ | ◯ |
| Ex. I-6 | F1 | Presence | 63.2 | ◯ | ◯ | ◯ | Δ | ◯ | ◯ |
| Ex. I-7 | G1 | Presence | 19.1 | ◯ | ◯ | ◯ | Δ | ◯ | Δ |
| Ex. I-8 | H1 | Presence | 34.2 | ◯ | ◯ | ◯ | Δ | ◯ | Δ |
| Ex. I-9 | I1 | Presence | 52.3 | ◯ | ◯ | ◯ | Δ | ◯ | Δ |
| Comp. Ex. I-1 | J1 | Presence | 16.5 | Δ | ◯ | ◯ | Δ | X | X |
| Comp. Ex. I-2 | K1 | Presence | 18.3 | Δ | ◯ | ◯ | Δ | X | X |
| Comp. Ex. I-3 | L1 | Presence | 32.4 | Δ | ◯ | ◯ | Δ | X | X |
| Comp. Ex. I-4 | M1 | Presence | 42.1 | Δ | ◯ | ◯ | Δ | X | X |
| Comp. Ex. I-5 | A1 | Absence | 21.4 | X | ◯ | ◯ | Δ | ◯ | ◯ |
| Comp. Ex. I-6 | B1 | Absence | 45.2 | X | ◯ | ◯ | Δ | ◯ | ◯ |
| Comp. Ex. I-7 | C1 | Absence | 68.7 | X | ◯ | ◯ | Δ | ◯ | ◯ |
| Comp. Ex. I-8 | D1 | Absence | 17.8 | X | ◯ | ◯ | Δ | ◯ | ◯ |
| Comp. Ex. I-9 | E1 | Absence | 34.9 | X | ◯ | ◯ | Δ | ◯ | ◯ |
| Comp. Ex. I-10 | F1 | Absence | 61.3 | X | ◯ | ◯ | Δ | ◯ | ◯ |
| Comp. Ex. I-11 | G1 | Absence | 17.2 | X | ◯ | ◯ | Δ | ◯ | Δ |
| Comp. Ex. I-12 | H1 | Absence | 32.9 | X | ◯ | ◯ | Δ | ◯ | Δ |
| Comp. Ex. I-13 | I1 | Absence | 50.4 | X | ◯ | ◯ | Δ | ◯ | Δ |

As evident from the results shown in the above Table 1, all of the ink jet recording materials for non-aqueous ink obtained in Examples I-1 to I-9 that are an ink jet recording material for non-aqueous ink, which comprises an ink-absorbing layer containing at least a pigment on a support, the ink-absorbing layer being coated or impregnated with a polymer soluble or swellable in a petroleum system high boiling point solvent, wherein at least 30 wt % of the pigment is calcium carbonate, were an ink jet recording material for non-aqueous ink, having a satisfactory ink solvent-absorbing property, a satisfactory anti-bleeding property preventing the ink solvent from bleeding out of the surrounding of a printed part as a lapse of time and an excellent fixing property. On the other hand, Comparative Example I-1 employing an ink-absorbing layer comprising silica in place of calcium carbonate and Comparative Examples I-2 to I-4 employing an ink-absorbing layer containing calcium carbonate in an amount of less than 30 wt % were poor in a performance of preventing “strike through” of ink. Also, Comparative Examples I-5 to I-13 employing no solvent-soluble polymer layer were poor in an ink fixing property.

### Example II-1

(Preparation of Ink-Absorbing Layer A2)

100 Parts by weight of kaolin (Amazon-88: particle size of at most 2 μm, manufactured by Mitsubishi Corp.), 8 parts by weight of polyvinyl alcohol (PVA-117: manufactured by Kuraray Co., Ltd.) and 0.24 part of glyoxal (Glyoxal GX: 40% aqueous solution, manufactured by Nihon Gosei Kagaku K.K.) were blended to prepare a coating solution. The coating solution thus prepared was coated on the above prepared support A in an amount of 20 g/m² by an air knife coater to prepare “ink-absorbing layer A2”.

A solvent-soluble coating solution was coated on the above prepared ink-absorbing layer A2 in a dry coated amount of 5 g/m² by a wire bar to obtain an ink jet material for non-aqueous ink of Example II-1.

### Example II-2

(Preparation of Ink-Absorbing Layer B2)

The above prepared “ink-absorbing layer A2” was subjected to super-calendering treatment under a linear pressure of 1862 N/cm to prepare “ink-absorbing layer B2”, and a solvent-soluble polymer coating solution was coated on the ink-absorbing layer B2 in the same manner as in Example II-1 to obtain an ink jet recording material for non-aqueous ink of Example II-2.

### Example II-3

(Preparation of Ink-Absorbing Layer C2)

100 Parts by weight of kaolin (Amazon-88: particle size of at most 2 μm, manufactured by Mitsubishi Corp.), 8 parts by weight of polyvinyl alcohol (PVA-117: manufactured by Kuraray Co., Ltd.) and 0.24 part of glyoxal (Glyoxal GX: 40% aqueous solution, manufactured by Nihon Gosei Kagaku K.K.) were blended to prepare a coating solution. The coating solution thus prepared was coated on the above prepared support A in an amount of 20 g/m² by an air knife coater, and was dried by pressing the coated surface to a mirror-finished roll having a surface temperature of 90° C. to prepare “ink-absorbing layer C2”, and a solvent-soluble polymer coating solution was coated on the ink-absorbing layer C2 in the same manner as in Example II-1 to obtain an ink jet recording material for non-aqueous ink of Example II-3.

### Example II-4

(Preparation of Ink-Absorbing Layer D2)

“Ink-receiving layer D2” was prepared in the same manner as in Example H-1, except that 50 parts by weight of kaolin (Amazon-88: particle size of at most 2 μm, manufactured by Mitsubishi Corp.) and 50 parts by weight of synthetic amorphous silica (Mizukasil P78A®: average particle size 3.3 μm, manufactured by Mizusawa Industrial Chemicals Ltd.), were used in place of 100 parts by weight of kaolin, and a solvent-soluble polymer coating solution was coated on the ink-absorbing layer D1 in the same manner as in Example II-1 to obtain an ink jet recording material for non-aqueous ink of Example II-4.

### Example II-5

(Preparation of Ink-Absorbing Layer E2)

The above prepared “ink-absorbing layer D2” was subjected to super-calendering treatment under a linear pressure of 1862 N/cm to prepare “ink-absorbing layer E2”, and a solvent-soluble polymer coating solution was coated on the ink-absorbing layer E2 in the same manner as in Example II-1 to obtain an ink jet recording material for non-aqueous ink of Example II-5.

### Example II-6

(Preparation of Ink-Absorbing Layer F2)

50 Parts by weight of kaolin (Amazon-88: particle size of at most 2 μm, manufactured by Mitsubishi Corp.), 50 parts by weight of synthetic amorphous silica (Mizukasil P78A®: average particle size 3.3 μm, manufactured by Mizusawa Industrial Chemicals Ltd.), 8 parts by weight of polyvinyl alcohol (PVA-117: manufactured by Kuraray Co., Ltd.) and 0.24 part of glyoxal (Glyoxal GX: 40% aqueous solution, manufactured by Nihon Gosei Kagaku K.K.) to prepare a coating solution. The coating solution thus prepared was coated on the above prepared support A in an amount of 20 g/m² by an air knife coater, and was dried by pressing the coated surface to a mirror-finished roll having a surface temperature of 90° C. to prepare “ink-absorbing layer F2”, and a solvent-soluble polymer coating solution was coated on the ink-absorbing layer F2 in the same manner as in Example II-1 to obtain an ink jet recording material for non-aqueous ink of Example II-6.

### Example II-7

(Preparation of Ink-Absorbing Layer G2) “Ink-receiving layer G2” was prepared in the same manner as in Example II-1, except that 35 parts by weight of kaolin (Amazon-88: particle size of at most 2 μm, manufactured by Mitsubishi Corp.) and 65 parts by weight of synthetic amorphous silica (Mizukasil P78A®: average particle size 3.3 μm, manufactured by Mizusawa Industrial Chemicals Ltd.), were used in place of 100 parts by weight of kaolin, and a solvent-soluble polymer coating solution was coated on the ink-absorbing layer G2 in the same manner as in Example II-1 to obtain an ink jet recording material for non-aqueous ink of Example II-7.

### Example II-8

(Preparation of Ink-Absorbing Layer H2)

The above prepared “ink-absorbing layer G2” was subjected to super-calendering treatment under a linear pressure of 1862 N/cm to prepare “ink-absorbing layer H2”, and a solvent-soluble polymer coating solution was coated on the ink-absorbing layer H2 in the same manner as in Example II-1 to obtain an ink jet recording material for non-aqueous ink of Example II-8.

### Example II-9

(Preparation of Ink-Absorbing Layer I2)

35 Parts by weight of kaolin (Amazon-88: particle size of at most 2 μm, manufactured by Mitsubishi Corp.), 65 parts by weight of synthetic amorphous silica (Mizukasil P78A®: average particle size 3.3 μm, manufactured by Mizusawa Industrial Chemicals Ltd.), 8 parts by weight of polyvinyl alcohol (PVA-117: manufactured by Kuraray Co., Ltd.) and 0.24 part of glyoxal (Glyoxal GX: 40% aqueous solution, manufactured by Nihon Gosei Kagaku K.K.) were blended to prepare a coating solution. The coating solution thus prepared was coated on the above prepared support A in an amount of 20 g/m² by an air knife coater, and was dried by pressing the coated surface to a mirror-finished roll having a surface temperature of 90° C. to prepare “ink-absorbing layer I2”, and a solvent-soluble polymer coating solution was coated on the ink-absorbing layer I2 in the same manner as in Example II-1 to obtain an ink jet recording material for non-aqueous ink of Example II-9.

### Comparative Example II-1

(Preparation of Ink-Absorbing Layer J2)

“Ink-absorbing layer J2” was prepared in the same manner as in Example H-1, except that 100 parts by weight of synthetic amorphous silica (Mizukasil P78A®: average particle size 3.3 μm, manufactured by Mizusawa Industrial Chemicals Ltd.) was used in place of 100 parts by weight of kaolin, and a solvent-soluble polymer coating solution was coated on the ink-absorbing layer J2 in the same manner as in Example II-1 to obtain an ink jet recording material for non-aqueous ink of Comparative Example II-1.

### Comparative Example II-2

(Preparation of Ink-Absorbing Layer K2)

“Ink-absorbing layer K2” was prepared in the same manner as in Example II-1, except that 20 parts by weight of kaolin (Amazon-88: particle size of at most 2 μm, manufactured by Mitsubishi Corp.) and 80 parts by weight of synthetic amorphous silica (Mizukasil P78A®: average particle size 3.3 μm, manufactured by Mizusawa Industrial Chemicals Ltd.), were used in place of 100 parts by weight of kaolin, and a solvent-soluble polymer coating solution was coated on the ink-absorbing layer K2 in the same manner as in Example II-1 to obtain an ink jet recording material for non-aqueous ink of Comparative Example II-2.

### Comparative Example II-3

(Preparation of Ink-Absorbing Layer L2)

The above prepared “ink-absorbing layer K2” was subjected to super-calendering treatment under a linear pressure of 1862 N/cm to prepare “ink-absorbing layer L2”, and a solvent-soluble polymer coating solution was coated on the ink-absorbing layer L2 in the same manner as in Example II-1 to obtain an ink jet recording material for non-aqueous ink of Comparative Example II-3.

### Comparative Example II-4

(Preparation of Ink-Absorbing Layer M2)

20 Parts by weight of kaolin (Amazon-88: particle size of at most 2 μm, manufactured by Mitsubishi Corp.), 80 parts by weight of synthetic amorphous silica (Mizukasil P78A®: average particle size 3.3 μm, manufactured by Mizusawa Industrial Chemicals Ltd.), 8 parts by weight of polyvinyl alcohol (PVA-117: manufactured by Kuraray Co., Ltd.) and 0.24 part of glyoxal (Glyoxal GX: 40% aqueous solution, manufactured by Nihon Gosei Kagaku K.K.) were blended to prepare a coating solution. The coating solution thus prepared was coated on the above prepared support A in an amount of 20 g/m² by an air knife coater, and was dried by pressing the coated surface to a mirror-finished roll having a surface temperature of 90° C. to prepare “ink-absorbing layer M2”, and a solvent-soluble polymer coating solution was coated on the ink-absorbing layer M2 in the same manner as in Example II-1 to obtain an ink jet recording material for non-aqueous ink of Comparative Example II-4.

### Comparative Example II-5

An ink jet recording material for non-aqueous ink of Comparative Example II-5 was obtained in the same manner as in Example II-1, except that a solvent-soluble polymer coating solution was not coated.

### Comparative Example II-6

An ink jet recording material for non-aqueous ink of Comparative Example II-6 was obtained in the same manner as in Example II-2, except that a solvent-soluble polymer coating solution was not coated.

### Comparative Example 11-7

An ink jet recording material for non-aqueous ink of Comparative Example II-7 was obtained in the same manner as in Example II-3, except that a solvent-soluble polymer coating solution was not coated.

### Comparative Example II-8

An ink jet recording material for non-aqueous ink of Comparative Example II-8 was obtained in the same manner as in Example II-4, except that a solvent-soluble polymer coating solution was not coated.

### Comparative Example II-9

An ink jet recording material for non-aqueous ink of Comparative Example II-9 was obtained in the same manner as in Example II-5, except that a solvent-soluble polymer coating solution was not coated.

### Comparative Example II-10

An ink jet recording material for non-aqueous ink of Comparative Example II-10 was obtained in the same manner as in Example II-6, except that a solvent-soluble polymer coating solution was not coated.

### Comparative Example II-11

An ink jet recording material for non-aqueous ink of Comparative Example II-11 was obtained in the same manner as in Example II-7, except that a solvent-soluble polymer coating solution was not coated.

### Comparative Example II-12

An ink jet recording material for non-aqueous ink of Comparative Example II-12 was obtained in the same manner as in Example II-8, except that a solvent-soluble polymer coating solution was not coated.

### Comparative Example II-13

An ink jet recording material for non-aqueous ink of Comparative Example II-13 was obtained in the same manner as in Example II-9, except that a solvent-soluble polymer coating solution was not coated.

The ink jet recording materials for non-aqueous ink obtained in the above Examples II-1 to II-9 and Comparative Examples II-2 to II-13 were evaluated as mentioned above, and the evaluation results are shown in the following Table 2.

TABLE 2

| | Ink- | Solvent- | | | Ink-absorbing property | | | Ink | |
|---|---|---|---|---|---|---|---|---|---|
| | absorbing | soluble | | Fixing | Mono | Double | Triple | strike | Bleeding |
| | layer | polymer | Glossiness | property | color | color | color | through | property |
| Ex. II-1 | A2 | Presence | 35.4 | ◯ | ◯ | ◯ | Δ | ◯ | ◯ |
| Ex. II-2 | B2 | Presence | 63.2 | ◯ | ◯ | ◯ | Δ | ◯ | ◯ |
| Ex. II-3 | C2 | Presence | 82.1 | ◯ | ◯ | ◯ | Δ | ◯ | ◯ |
| Ex. II-4 | G2 | Presence | 22.0 | ◯ | ◯ | ◯ | Δ | ◯ | ◯ |
| Ex. II-5 | H2 | Presence | 45.3 | ◯ | ◯ | ◯ | Δ | ◯ | ◯ |
| Ex. II-6 | I2 | Presence | 68.6 | ◯ | ◯ | ◯ | Δ | ◯ | ◯ |
| Ex. II-7 | D2 | Presence | 21.0 | ◯ | ◯ | ◯ | Δ | ◯ | Δ |
| Ex. II-8 | E2 | Presence | 40.6 | ◯ | ◯ | ◯ | Δ | ◯ | Δ |
| Ex. II-9 | F2 | Presence | 58.4 | ◯ | ◯ | ◯ | Δ | ◯ | Δ |
| Comp. Ex. II-1 | J2 | Presence | 16.2 | Δ | ◯ | ◯ | Δ | X | X |
| Comp. Ex. II-2 | K2 | Presence | 20.1 | Δ | ◯ | ◯ | Δ | X | X |
| Comp. Ex. II-3 | L2 | Presence | 35.8 | Δ | ◯ | ◯ | Δ | X | X |
| Comp. Ex. II-4 | M2 | Presence | 45.1 | Δ | ◯ | ◯ | Δ | X | X |
| Comp. Ex. II-5 | A2 | Absence | 33.1 | X | ◯ | ◯ | Δ | ◯ | ◯ |
| Comp. Ex. II-6 | B2 | Absence | 59.8 | X | ◯ | ◯ | Δ | ◯ | ◯ |
| Comp. Ex. II-7 | C2 | Absence | 80.4 | X | ◯ | ◯ | Δ | ◯ | ◯ |
| Comp. Ex. II-8 | G2 | Absence | 19.5 | X | ◯ | ◯ | Δ | ◯ | ◯ |
| Comp. Ex. II-9 | H2 | Absence | 43.1 | X | ◯ | ◯ | Δ | ◯ | ◯ |
| Comp. Ex. II-10 | I2 | Absence | 65.1 | X | ◯ | ◯ | Δ | ◯ | ◯ |
| Comp. Ex. II-11 | D2 | Absence | 18.9 | X | ◯ | ◯ | Δ | ◯ | Δ |
| Comp. Ex. II-12 | E2 | Absence | 38.5 | X | ◯ | ◯ | Δ | ◯ | Δ |
| Comp. Ex. II-13 | F2 | Absence | 56.1 | X | ◯ | ◯ | Δ | ◯ | Δ |

As evident from the results shown in the above Table 2, all of the ink jet recording materials for non-aqueous ink obtained in Examples II-1 to II-9 that are an ink jet recording material for non-aqueous ink, which comprises an ink-absorbing layer containing at least a pigment on a support, the ink-absorbing layer being coated or impregnated with a polymer soluble or swellable in a petroleum system high boiling point solvent, wherein at least 30 wt % of the pigment is kaolin, were an ink jet recording material for non-aqueous ink, having a satisfactory ink solvent-absorbing property, a satisfactory anti-bleeding property preventing the ink solvent from bleeding out of the surrounding of a printed part as a lapse of time and an excellent fixing property. On the other hand, Comparative Example II-1 employing an ink-absorbing layer comprising silica in place of kaolin and Comparative Examples II-2 to II-4 employing an ink-absorbing layer containing kaolin in an amount of less than 30 wt % were poor in a performance of preventing “strike through” of ink. Also, Comparative Examples II-5 to II-13 employing no solvent-soluble polymer layer were poor in an ink fixing property.

(Preparation of support B)

Support B was obtained by incorporating 5 parts of a pigment comprising light calcium carbonate/heavy calcium carbonate/talc (ratio of=30/35/35), 0.1 part of a commercially available alkyl ketene dimer, 0.03 part of a commercially available cationic polyacrylamide, 1.0 part of a commercially available cationized starch and 0.5 part of aluminum sulfate into a wood pulp comprising 100 parts of LBKP having a freeness of 450 ml CSF, and applying the resultant mixture to a Fourdrinier paper-making machine to obtain support B having a weight of 90 g/m². The support B thus obtained had a gas-permeability of 20 seconds.

### Example III-1

(Preparation of Ink-Absorbing Layer A3)

100 Parts by weight of barium sulfate having an average particle size of 0.8 μm, 8 parts by weight of gelatin and 0.24 part by weight of chromium sulfate were blended to prepare a coating solution. The coating solution thus prepared was coated on the above prepared support B in an amount of 20 g/m² by an air knife coater to prepare “ink-absorbing layer A3”.

A solvent-soluble coating solution was coated on the above prepared ink-absorbing layer A3 in a dry coated amount of 5 g/m² by a wire bar to obtain an ink jet material for non-aqueous ink of Example III-1.

### Example III-2

(Preparation of Ink-Absorbing Layer B3)

The above prepared “ink-absorbing layer A3” was subjected to super-calendering treatment under a linear pressure of 1862 N/cm to prepare “ink-absorbing layer B3”.

An ink jet recording material for non-aqueous ink of Example III-2 was obtained in the same manner as in Example III-1, except that the ink-absorbing layer B3 was used in place of the ink-absorbing layer A3.

### Example III-3

(Preparation of Ink-Absorbing Layer C3)

100 Parts by weight of barium sulfate having an average particle size of 0.8 μm, 8 parts by weight of gelatin and 0.24 part by weight of chromium sulfate were blended to prepare a coating solution. The coating solution thus prepared was coated on the above prepared support B in an amount of 20 g/m² by an air knife coater, and was dried by pressing the coated surface to a mirror-finished roll having a surface temperature of 90° C. to prepare “ink-absorbing layer C3”.

An ink jet recording material for non-aqueous ink of Example III-3 was obtained in the same manner as in Example III-1, except that the ink-absorbing layer C3 was used in place of the ink-absorbing layer A3.

### Comparative Example III-1

(Preparation of Ink-Absorbing Layer D3)

“Ink-absorbing layer D3” was prepared in the same manner as in Example III-1, except that a synthetic amorphous silica having an average particle size of 3.3 μm was used in place of barium sulfate.

An ink jet recording material for non-aqueous ink of Comparative Example III-1 was obtained in the same manner as in Example III-1, except that the ink-absorbing layer D3 was used in place of the ink-absorbing layer A3.

### Comparative Example III-2

An ink jet recording material for non-aqueous ink of Comparative Example III-2 was obtained by using the ink-absorbing layer A3 as it is without coating a solvent-soluble polymer coating solution.

### Comparative Example III--3

An ink jet recording material for non-aqueous ink of Comparative Example III-3 was obtained by using the ink-absorbing layer B3 as it is without coating a solvent-soluble polymer coating solution.

### Comparative Example III-4

An ink jet recording material for non-aqueous ink of Comparative Example III-4 was obtained by using the ink-absorbing layer C3 as it is without coating a solvent-soluble polymer coating solution.

### Comparative Example III-5

An ink jet recording material for non-aqueous ink of Comparative Example III-5 was obtained by using the ink-absorbing layer D3 as it is without coating a solvent-soluble polymer coating solution.

The ink jet recording materials for non-aqueous ink obtained in the above Examples III-1 to III-3 and Comparative Examples III-1 to III-5 were evaluated as mentioned above, and the evaluation results are shown in the following Table 3.

TABLE 3

| | Ink- | Solvent- | | | Ink-absorbing property | | | Ink | |
|---|---|---|---|---|---|---|---|---|---|
| | absorbing | soluble | | Fixing | Mono | Double | Triple | strike | Bleeding |
| | layer | polymer | Glossiness | property | color | color | color | through | property |
| Ex. III-1 | A3 | Presence | 21.9 | ◯ | ◯ | ◯ | Δ | ◯ | ◯ |
| Ex. III-2 | B3 | Presence | 52.4 | ◯ | ◯ | ◯ | Δ | ◯ | ◯ |
| Ex. III-3 | C3 | Presence | 75.3 | ◯ | ◯ | ◯ | Δ | ◯ | ◯ |
| Comp. Ex. III-1 | D3 | Presence | 18.6 | Δ | ◯ | ◯ | Δ | X | X |
| Comp. Ex. III-2 | A3 | Absence | 20.3 | X | ◯ | ◯ | Δ | Δ | ◯ |
| Comp. Ex. III-3 | B3 | Absence | 51.6 | X | ◯ | ◯ | Δ | Δ | ◯ |
| Comp. Ex. III-4 | C3 | Absence | 73.4 | X | ◯ | ◯ | Δ | Δ | ◯ |
| Comp. Ex. III-5 | D3 | Absence | 17.8 | X | ◯ | ◯ | Δ | X | X |

As evident from the results shown in the above Table 3, all of the ink jet recording materials for non-aqueous ink obtained in Examples III-1 to III-3 that are an ink jet recording material for non-aqueous ink, which comprises an ink-absorbing layer containing at least a pigment on a support, the ink-absorbing layer being coated or impregnated with a polymer soluble or swellable in a petroleum system high boiling point solvent, wherein the pigment is barium sulfate, were an ink jet recording material for non-aqueous ink, having a satisfactory ink solvent-absorbing property, a satisfactory anti-bleeding property preventing the ink solvent from bleeding out of the surrounding of a printed part as a lapse of time and an excellent fixing property. On the other hand, Comparative Examples III-1 and III-5 employing an ink-absorbing layer comprising silica in place of barium sulfate were poor in a performance of preventing “strike through” of ink and also poor in the anti-bleeding property. Also, Comparative Examples III-2, III-3 and III-4 employing no solvent-soluble polymer layer were poor in an ink fixing property.

(Preparation of Support C)

Support C was obtained by incorporating 5 parts of a pigment comprising light calcium carbonate/heavy calcium carbonate/talc (ratio of=30/35/35), 0.1 part of a commercially available alkyl ketene dimer, 0.03 part of a commercially available cationic polyacrylamide, 1.0 part of a commercially available cationized starch and 0.5 part of aluminum sulfate into a wood pulp comprising 100 parts of LBKP having a freeness of 450 ml CSF, and applying the resultant mixture to a Fourdrinier paper-making machine to obtain support C having a weight of 90 g/m².

(Preparation of Undercoat Layer Coating Solution a)

100 Parts by weight of barium sulfate having an average particle size of 0.8 μm and 8 parts by weight of polyvinyl alcohol were blended to prepare “undercoating layer coating solution a”.

(Preparation of Undercoat Layer Coating Solution b)

100 Parts by weight of light calcium carbonate (Albagloss: particle size 0.6 to 0.8 μm, manufactured by Mintec Japan K.K.) and 8 parts by weight of polyvinyl alcohol were blended to prepare “undercoating layer coating solution b”.

(Preparation of Undercoat Layer Coating Solution c)

100 Parts by weight of titanium oxide (Tipeque R-820: particle size 0.25 μm, manufactured by ISHIHARA SANGYO KAISHA LTD.) and 8 parts by weight of polyvinyl alcohol were blended to prepare “undercoating layer coating solution c”.

(Preparation of Undercoat Layer Coating Solution d)

100 Parts by weight of kaolin (Amazon-88: particle size of at most 2 μm, manufactured by Mitsubishi Corp.) and 8 parts by weight of polyvinyl alcohol were blended to prepare “undercoating layer coating solution d”.

(Preparation of Ink-Absorbing Layer Coating Solution A4)

150 Parts of silica sol (Snowtex-O®: solid content 20%, manufactured by Nissan Chemical Industries), 100 parts of synthetic amorphous silica (Mizukasil P78F®: manufactured by Mizusawa Industrial Chemicals Ltd.), 2 parts of a fluorescent whitening agent (Kaycall BBL®: solid content 50%, manufactured by Nippon Soda Co., Ltd.) and 250 parts of a 10% aqueous solution of polyvinyl alcohol (PVA-117: manufactured by Kuraray Co., Ltd.) were blended in 580 parts of water with stirring to prepare “ink-absorbing layer coating solution A4”.

(Preparation of Ink-Absorbing Layer Coating Solution B4)

250 Parts of silica sol (Snowtex-XL®: solid content 40%, manufactured by Nissan Chemical Industries), 62.5 parts of styrene-butadiene type latex (JSR-0691®: solid content 48%, manufactured by JSR Corporation) and 2 parts of potassium oleate were blended in 285.5 parts of water with stirring to prepare “ink-absorbing layer coating solution B4”.

### Example VI-1

The undercoat layer coating solution a was coated on the above prepared support C in a dry coated amount of 15 g/m² by a wire bar, and the ink-absorbing layer coating solution A4 was further coated thereon in a dry coated amount of 5 g/m² by a wire bar. Further, the solvent-soluble polymer coating solution was coated thereon in a dry coated amount of 5 g/m² by a wire bar to obtain an ink jet recording material for non-aqueous ink of Example IV-1.

### Example VI-2

An ink jet recording material for non-aqueous ink of Example VI-2 was obtained in the same manner as in Example VI-1, except that the undercoat layer coating solution b was used in place of the undercoat layer coating solution a.

### Example VI-3

An ink jet recording material for non-aqueous ink of Example VI-3 was obtained in the same manner as in Example VI-1, except that the undercoat layer coating solution c was used in place of the undercoat layer coating solution a.

### Example VI-4

An ink jet recording material for non-aqueous ink of Example VI-4 was obtained in the same manner as in Example VI-1, except that the undercoat layer coating solution d was used in place of the undercoat layer coating solution a.

### Example VI-5

The “undercoat layer coating solution a” was coated on the above prepared support C in a dry coated amount of 15 g/m² by a wire bar, and the ink-absorbing layer coating solution A4 was further coated thereon in a dry coated amount of 5 g/m² by a wire bar. Further, the ink-absorbing layer coating solution B4 was coated thereon in a dry coated amount of 3 g/m² by a wire bar. The product thus obtained was subjected to super-calendering treatment under a linear pressure of 1862 N/cm, and the solvent-soluble polymer coating solution was coated thereon in a dry coated amount of 5 g/m² by a wire bar to obtain an ink jet recording material for non-aqueous ink of Example VI-5.

### Example VI-6

An ink jet recording material for non-aqueous ink of Example VI-6 was obtained in the same manner as in Example VI-5, except that the undercoat layer coating solution b was used in place of the undercoat layer coating solution a.

### Example VI-7

An ink jet recording material for non-aqueous ink of Example VI-7 was obtained in the same manner as in Example VI-5, except that the undercoat layer coating solution c was used in place of the undercoat layer coating solution a.

### Example VI-8

An ink jet recording material for non-aqueous ink of Example VI-8 was obtained in the same manner as in Example VI-5, except that the undercoat layer coating solution d was used in place of the undercoat layer coating solution a.

### Example VI-9

The “undercoat layer coating solution a” was coated on the above prepared support C in a dry coated amount of 15 g/m² by a wire bar, and the ink-absorbing layer coating solution A4 was further coated thereon in a dry coated amount of 5 g/m² by a wire bar. Further, the ink-absorbing layer coating solution B4 was coated thereon in a dry coated amount of 3 g/m² by a wire bar, and the coated surface in wet state was pressed onto a mirror-finished roll having a surface temperature of 90° C. for drying. The solvent-soluble polymer coating solution was than coated thereon in a dry coated amount of 5 g/m² by a wire bar to obtain an ink jet recording material for non-aqueous ink of Example VI-9.

### Example VI-10

An ink jet recording material for non-aqueous ink of Example VI-10 was obtained in the same manner as in Example VI-9, except that the undercoat layer coating solution b was used in place of the undercoat layer coating solution a.

### Example VI-11

An ink jet recording material for non-aqueous ink of Example VI-11 was obtained in the same manner as in Example VI-9, except that the undercoat layer coating solution c was used in place of the undercoat layer coating solution a.

### Example IV-12

An ink jet recording material for non-aqueous ink of Example VI-12 was obtained in the same manner as in Example VI-9, except that the undercoat layer coating solution d was used in place of the undercoat layer coating solution a.

### Comparative Example VI-1

An ink jet recording material for non-aqueous ink of Comparative Example VI-1 was obtained by coating the “undercoat layer coating solution a” on the above prepared support C in a dry coated amount of 15 g/m² by a wire bar and further coating the ink-absorbing layer coating solution A4 thereon in a dry coated amount of 5 g/m² by a wire bar without subjecting to gloss-developing treatment.

### Comparative Example VI-2

An ink jet recording material for non-aqueous ink of Comparative Example VI-2 was obtained in the same manner as in Comparative Example VI-1, except that the undercoat layer coating solution b was used in place of the undercoat layer coating solution a.

### Comparative Example VI-3

An ink jet recording material for non-aqueous ink of Comparative Example VI-3 was obtained in the same manner as in Comparative Example VI-1, except that the undercoat layer coating solution c was used in place of the undercoat layer coating solution a.

### Comparative Example VI-4

An ink jet recording material for non-aqueous ink of Comparative Example VI-4 was obtained in the same manner as in Comparative Example IV-1, except that the undercoat layer coating solution d was used in place of the undercoat layer coating solution a.

### Comparative Example VI-5

The “undercoat layer coating solution a” was coated on the above prepared support C in a dry coated amount of 15 g/m² by a wire bar, and the ink-absorbing layer coating solution A4 was further coated thereon in a dry coated amount of 5 g/m² by a wire bar. Further, the ink-absorbing layer coating solution B4 was coated thereon in a dry coated amount of 3 g/m² by a wire bar. The product thus obtained was subjected to super-calendering treatment under a linear pressure of 1862 N/cm to obtain an ink jet recording material for non-aqueous ink of Comparative Example VI-5 without coating the solvent-soluble polymer coating solution.

### Comparative Example VI-6

An ink jet recording material for non-aqueous ink of Comparative Example VI-6 was obtained in the same manner as in Comparative Example VI-5, except that the undercoat layer coating solution b was used in place of the undercoat layer coating solution a.

### Comparative Example VI-7

An ink jet recording material for non-aqueous ink of Comparative Example VI-7 was obtained in the same manner as in Comparative Example VI-5, except that the undercoat layer coating solution c was used in place of the undercoat layer coating solution a.

### Comparative Example VI-8

An ink jet recording material for non-aqueous ink of Comparative Example VI-8 was obtained in the same manner as in Comparative Example VI-5, except that the undercoat layer coating solution d was used in place of the undercoat layer coating solution a.

### Comparative Example VI-9

The “undercoat layer coating solution a” was coated on the above prepared support C in a dry coated amount of 15 g/m² by a wire bar, and the ink-absorbing layer coating solution A4 was further coated thereon in a dry coated amount of 5 g/m² by a wire bar. Further, the ink-absorbing layer coating solution B4 was coated thereon in a dry coated amount of 3 g/m² by a wire bar, and the coated surface in wet state was pressed onto a mirror-finished roll having a surface temperature of 90° C. for drying to obtain an ink jet recording material for non-aqueous ink of Comparative Example VI-9 without coating the solvent-soluble polymer coating solution.

### Comparative Example VI-10

An ink jet recording material for non-aqueous ink of Comparative Example VI-10 was obtained in the same manner as in Comparative Example VI-9, except that the undercoat layer coating solution b was used in place of the undercoat layer coating solution a.

### Comparative Example VI-11

An ink jet recording material for non-aqueous ink of Comparative Example VI-11 was obtained in the same manner as in Comparative Example VI-9, except that the undercoat layer coating solution c was used in place of the undercoat layer coating solution a.

### Comparative Example IV-12

An ink jet recording material for non-aqueous ink of Comparative Example VI-12 was obtained in the same manner as in Comparative Example VI-9, except that the undercoat layer coating solution d was used in place of the undercoat layer coating solution a.

### Comparative Example VI-13

The ink-absorbing layer coating solution A4 was coated on the above prepared support C in a dry coated amount of 5 g/m² by a wire bar, and the solvent-soluble polymer coating solution was coated thereon in a dry coated amount of 5 g/m² by a wire bar to obtain an ink jet recording material for non-aqueous ink of Comparative Example VI-13.

### Comparative Example VI-14

The ink-absorbing layer coating solution A4 was coated on the above prepared support C in a dry coated amount of 5 g/m² by a wire bar, and the ink-absorbing layer coating solution B4 was further coated thereon in a dry coated amount of 3 g/m² by a wire bar. The product thus prepared was subjected to super-calendering treatment under a linear pressure of 1862 N/cm, and the solvent-soluble polymer coating solution was coated thereon in a dry coated amount of 5 g/m² by a wire bar to obtain an ink jet recording material for non-aqueous ink of Comparative Example VI-14.

### Comparative Example VI-15

The ink-absorbing layer coating solution A4 was coated on the above prepared support C in a dry coated amount of 5 g/m² by a wire bar, and the ink-absorbing layer coating solution B4 was further coated thereon in a dry coated amount of 3 g/m² by a wire bar, and the coated surface in wet state was pressed onto a mirror-finished roll having a surface temperature of 90° C. for drying. The solvent-soluble polymer coating solution was further coated thereon in a dry coated amount of 5 g/m² by a wire bar to obtain an ink jet recording material for non-aqueous ink of Comparative Example VI-15.

### Comparative Example VI-16

An ink jet recording material for non-aqueous ink of Comparative Example VI-16 was obtained simply by coating the ink-absorbing layer coating solution A4 on the above prepared support C in a dry coated amount of 5 g/m² by a wire bar.

### Comparative Example VI-17

An ink jet recording material for non-aqueous ink of Comparative Example VI-17 was obtained by coating the ink-absorbing layer coating solution A4 on the above prepared support C in a dry coated amount of 5 g/m² by a wire bar, further coating the ink-absorbing layer coating solution B4 thereon in a dry coated amount of 3 g/m² by a wire bar, and then subjecting the resultant product to super-calendering treatment under a linear pressure of 1862 N/cm.

### Comparative Example VI-18

An ink jet recording material for non-aqueous ink of Comparative Example VI-18 was obtained by coating the ink-absorbing layer coating solution A4 on the above prepared support C in a dry coated amount of 5 g/m² by a wire bar, further coating the ink-absorbing layer coating solution B4 thereon in a dry coated amount of 3 g/m² by a wire bar, and then pressing the coated surface in wet state onto a mirror-finished roll having a surface temperature of 90° C. for drying.

### Comparative Example VI-19

An ink jet recording material for non-aqueous ink of Comparative Example VI-19 was obtained by coating the “undercoat layer coating solution a” on the above prepared support C in a dry coated amount of 30 g/m² by a wire bar and then coating the solvent-soluble polymer coating solution thereon in a dry coated amount of 5 g/m² by a wire bar.

### Comparative Example VI-20

An ink jet recording material for non-aqueous ink of Comparative Example VI-20 was obtained simply by coating the “undercoat layer coating solution a” on the above prepared support C in a dry coated amount of 30 g/m² by a wire bar.

The ink jet recording materials for non-aqueous ink obtained in the above Examples VI-1 to VI-12 and Comparative Examples VI-1 to VI-20 were evaluated as mentioned above, and the evaluation results are shown in the following Tables 4 and 5.

TABLE 4

| | | Ink-absorbing | | | | | | | | | |
|---|---|---|---|---|---|---|---|---|---|---|---|
| | | layer | | | | | Ink-absorbing | | | | |
| | Under- | | Gloss- | Solvent- | | | property | | | Ink | |
| | coat | Coating | developing | soluble | Glossi- | Fixing | Mono | Double | Triple | strike | Bleeding |
| | layer | solution | treatment | polymer | ness | property | color | color | color | through | property |
| Ex. IV-1 | a | A4 | Absence | Presence | 22.9 | ◯ | ◯ | ◯ | Δ | ◯ | ◯ |
| Ex. IV-2 | b | A4 | Absence | Presence | 21.7 | ◯ | ◯ | ◯ | Δ | ◯ | ◯ |
| Ex. IV-3 | c | A4 | Absence | Presence | 22.4 | ◯ | ◯ | ◯ | Δ | ◯ | ◯ |
| Ex. IV-4 | d | A4 | Absence | Presence | 21.8 | ◯ | ◯ | ◯ | Δ | ◯ | ◯ |
| Ex. IV-5 | a | A4 + B4 | Super- | Presence | 54.6 | ◯ | ◯ | ◯ | Δ | ◯ | ◯ |
| | | | calender | | | | | | | | |
| Ex. IV-6 | b | A4 + B4 | Super- | Presence | 56.5 | ◯ | ◯ | ◯ | Δ | ◯ | ◯ |
| | | | calender | | | | | | | | |
| Ex. IV-7 | c | A4 + B4 | Super- | Presence | 55.8 | ◯ | ◯ | ◯ | Δ | ◯ | ◯ |
| | | | calender | | | | | | | | |
| Ex. IV-8 | d | A4 + B4 | Super- | Presence | 56.2 | ◯ | ◯ | ◯ | Δ | ◯ | ◯ |
| | | | calender | | | | | | | | |
| Ex. IV-9 | a | A4 + B4 | Cast | Presence | 82.4 | ◯ | ◯ | ◯ | Δ | ◯ | ◯ |
| Ex. IV-10 | b | A4 + B4 | Cast | Presence | 80.8 | ◯ | ◯ | ◯ | Δ | ◯ | ◯ |
| Ex. IV-11 | c | A4 + B4 | Cast | Presence | 81.9 | ◯ | ◯ | ◯ | Δ | ◯ | ◯ |
| Ex. IV-12 | d | A4 + B4 | Cast | Presence | 80.7 | ◯ | ◯ | ◯ | Δ | ◯ | ◯ |

TABLE 5

| | | Ink-absorbing | | | | | | | | | |
|---|---|---|---|---|---|---|---|---|---|---|---|
| | | layer | | | | | Ink-absorbing | | | | |
| | Under- | | Gloss- | Solvent- | | | property | | | Ink | |
| | coat | Coating | developing | soluble | Glossi- | Fixing | Mono | Double | Triple | strike | Bleeding |
| | layer | solution | treatment | polymer | ness | property | color | color | color | through | property |
| Comp. | a | A4 | Absence | Absence | 19.8 | X | ◯ | ◯ | Δ | ◯ | Δ |
| Ex. IV-I | | | | | | | | | | | |
| Comp. | b | A4 | Absence | Absence | 19.3 | X | ◯ | ◯ | Δ | ◯ | Δ |
| Ex. IV-2 | | | | | | | | | | | |
| Comp. | c | A4 | Absence | Absence | 18.7 | X | ◯ | ◯ | Δ | ◯ | Δ |
| Ex. IV-3 | | | | | | | | | | | |
| Comp. | d | A4 | Absence | Absence | 19.2 | X | ◯ | ◯ | Δ | ◯ | Δ |
| Ex. IV-4 | | | | | | | | | | | |
| Comp. | a | A4 + B4 | Super- | Absence | 52.1 | X | ◯ | ◯ | Δ | ◯ | Δ |
| Ex. IV-5 | | | calender | | | | | | | | |
| Comp. | b | A4 + B4 | Super- | Absence | 51.9 | X | ◯ | ◯ | Δ | ◯ | Δ |
| Ex. IV-6 | | | calender | | | | | | | | |
| Comp. | c | A4 + B4 | Super- | Absence | 53.4 | X | ◯ | ◯ | Δ | ◯ | Δ |
| Ex. IV-7 | | | calender | | | | | | | | |
| Comp. | d | A4 + B4 | Super- | Absence | 52.8 | X | ◯ | ◯ | Δ | ◯ | Δ |
| Ex. IV-8 | | | calender | | | | | | | | |
| Comp. | a | A4 + B4 | Cast | Absence | 81.3 | X | ◯ | ◯ | Δ | ◯ | Δ |
| Ex. IV-9 | | | | | | | | | | | |
| Comp. | b | A4 + B4 | Cast | Absence | 79.8 | X | ◯ | ◯ | Δ | ◯ | Δ |
| Ex. IV-10 | | | | | | | | | | | |
| Comp. | c | A4 + B4 | Cast | Absence | 78.9 | X | ◯ | ◯ | Δ | ◯ | Δ |
| Ex. IV-11 | | | | | | | | | | | |
| Comp. | d | A4 + B4 | Cast | Absence | 79.5 | X | ◯ | ◯ | Δ | ◯ | Δ |
| Ex. IV-12 | | | | | | | | | | | |
| Comp. | Absence | A4 | Absence | Presence | 18.2 | ◯ | ◯ | Δ | X | X | X |
| Ex. IV-13 | | | | | | | | | | | |
| Comp. | Absence | A4 + B4 | Super- | Presence | 48.5 | ◯ | ◯ | ◯ | X | X | X |
| Ex. IV-14 | | | calender | | | | | | | | |
| Comp. | Absence | A4 + B4 | Cast | Presence | 77.6 | ◯ | ◯ | Δ | X | X | X |
| Ex. IV-15 | | | | | | | | | | | |
| Comp. | Absence | A4 | Absence | Absence | 17.4 | X | ◯ | ◯ | X | X | X |
| Ex. IV-16 | | | | | | | | | | | |
| Comp. | Absence | A4 + B4 | Super- | Absence | 47.1 | X | ◯ | ◯ | X | X | X |
| Ex. IV-17 | | | calender | | | | | | | | |
| Comp. | Absence | A4 + B4 | Cast | Absence | 76.4 | X | ◯ | ◯ | X | X | X |
| Ex. IV-18 | | | | | | | | | | | |
| Comp. | a | Absence | Absence | Presence | 20.5 | ◯ | ◯ | ◯ | X | ◯ | ◯ |
| Ex. IV-19 | | | | | | | | | | | |
| Comp. | a | Absence | Absence | Absence | 19.1 | X | ◯ | ◯ | X | ◯ | Δ |
| Ex. IV-20 | | | | | | | | | | | |

As evident from the above Table 4, all of the ink jet recording materials for non-aqueous ink obtained in Examples VI-1 to VI-12 that are an ink jet recording material for non-aqueous ink, which comprises an ink-absorbing layer of at least one layer on a support, the ink-absorbing layer being coated or impregnated with a solvent-soluble polymer coating solution, wherein an undercoat layer containing at least one kind of a pigment selected from the group consisting of barium sulfate, calcium carbonate, titanium oxide and kaolin is provided between the support and the ink-absorbing layer, were an ink jet recording material for non-aqueous ink, having a satisfactory ink solvent-absorbing property, a satisfactory performance of inhibiting “strike through” of ink, a satisfactory anti-bleeding property preventing the ink solvent from bleeding out of the surrounding of a printed part as a lapse of time and an excellent fixing property. On the other hand, Comparative Examples VI-1 and VI-12, VI-16 to VI-18 and VI-20 having no solvent-soluble polymer layer were poor in a fixing property, and Comparative Examples VI-13 to VI-18 having no undercoat layer were poor in a performance of inhibiting “strike through” of ink and were poor also in an anti-bleeding property, and Comparative Examples VI-19 and VI-20 having no ink-absorbing layer were poor in an ink-absorbing property in a triple color-printed part.

As mentioned above, the present invention provides an ink jet recording material for non-aqueous ink, which has an excellent anti-bleeding property of non-aqueous ink, a satisfactory fixing property, a satisfactory ink-absorbing property and an excellent performance of inhibiting strike through of ink.

The entire disclosure of Japanese Patent Application No. 2000-22084 filed on Jan. 31, 2000, Japanese Patent Application No. 2000-58740 filed on Mar. 3, 2000, Japanese Patent Application No. 2000-74387 filed on Mar. 16, 2000 and Japanese Patent Application No. 2000-74388 filed on Mar. 16, 2000 including specification, claims and summary are incorporated herein by reference in their entireties.

What is claimed is:

1. An ink jet recording material for non-aqueous ink, which comprises an ink-absorbing layer containing at least a pigment on a support, the ink-absorbing layer being coated or impregnated with a polymer soluble or swellable in a petroleum system high boiling point solvent, wherein at least 30 wt % of the pigment is calcium carbonate.

2. An ink jet recording material for non-aqueous ink, which comprises an ink-absorbing layer containing at least a pigment on a support, the ink-absorbing layer being coated or impregnated with a polymer soluble or swellable in a petroleum system high boiling point solvent, wherein at least 30 wt % of the pigment is kaolin.

3. An ink jet recording material for non-aqueous ink, which comprises an ink-absorbing layer containing at least a pigment on a support, the ink-absorbing layer being coated or impregnated with a polymer soluble or swellable in a petroleum system high boiling point solvent, wherein the pigment is barium sulfate.

4. The ink jet recording material for non-aqueous ink according to claim 1, wherein the ink-absorbing layer has a surface smoothed by calendering treatment.

5. The ink jet recording material for non-aqueous ink according to claim 1, wherein the ink-absorbing layer has a surface smoothed by calendering treatment to make a surface, at least 20% of which has a 75° specular gloss.

6. The ink jet recording material for non-aqueous ink according to claim 1, wherein the ink-absorbing layer has a surface smoothed by casting treatment.

7. The ink jet recording material for non-aqueous ink according to claim 1, wherein the support is a gas-permeable support.

8. The ink jet recording material for non-aqueous ink according to claim 2, wherein the ink-absorbing layer has a surface smoothed by calendering treatment.

9. The ink jet recording material for non-aqueous ink according to claim 2, wherein the ink-absorbing layer has a surface smoothed by calendering treatment to make a surface, at least 20% of which has a 75° specular gloss.

10. The ink jet recording material for non-aqueous ink according to claim 2, wherein the ink-absorbing layer has a surface smoothed by casting treatment.

11. The ink jet recording material for non-aqueous ink according to claim 2, wherein the support is a gas-permeable support.

12. The ink jet recording material for non-aqueous ink according to claim 3, wherein the ink-absorbing layer has a surface smoothed by calendering treatment.

13. The ink jet recording material for non-aqueous ink according to claim 3, wherein the ink-absorbing layer has a surface smoothed by calendering treatment to make a surface, at least 20% of which has a 75° specular gloss.

14. The ink jet recording material for non-aqueous ink according to claim 3, wherein the ink-absorbing layer has a surface smoothed by casting treatment.

15. The ink jet recording material for non-aqueous ink according to claim 3, wherein the support is a gas-permeable support.

16. An ink jet recording material for non-aqueous ink, which comprises an ink-absorbing layer of at least one layer on a support, the ink-absorbing layer containing a polymer soluble or swellable in a petroleum system high boiling point solvent, wherein an undercoat layer containing at least one pigment selected from the group consisting of barium sulfate, calcium carbonate, titanium oxide and kaolin is provided between the support and the ink-absorbing layer.

17. The ink jet recording material for non-aqueous ink according to claim 16, wherein the outermost layer of the ink-absorbing layer is a gloss-developing layer.

18. The ink jet recording material for non-aqueous ink according to claim 17, wherein the gloss-developing layer has a gloss provided by pressing a wet gloss-developing layer onto a heated mirror-finished roll for drying.
